(19) United States
(12) Patent Application Publication
(10) Pub. No.: US 2002/0197412 A1
(43) Pub. Date: Dec. 26, 2002

(54) Flooring sealing method and device

(76) Inventor: Ronald G. Nicholson, Eudora, KS (US)

Correspondence Address: J. David Wharton, SHOOK, HARDY & BACON L.L.P., 1200 Main Street, Kansas City, MO, 64105-2118, US

(21) Appl. No.: 09/891,957

(22) Filed: Jun. 26, 2001

(51) Int. Cl. B05C 5/00

(52) U.S. Cl. 427/429; 239/172

(57) ABSTRACT

A device is provided that is adapted to be coupled with a vehicle for applying sealant supplied from a storage tank. The device includes a deck having at least one wheel in contact with the floor, a sealant applicator coupled with the deck and having a number of apertures along its length, and a sealant conveying line in fluid communication with the applicator and adapted to be coupled with the storage tank. The device also includes an elongated planar pad coupled with the deck and located at a distance from the applicator. The pad is adapted to be placed in contact with the floor to distribute the sealant across the floor after sealant is applied to the floor through the apertures of the applicator.

### CROSS-REFERENCE TO RELATED APPLICATIONS

“Not Applicable.”

### STATEMENT REGARDING FEDERALLY SPONSORED RESEARCH OR DEVELOPMENT

“Not Applicable.”

### BACKGROUND OF THE INVENTION

This invention relates generally to a device and method for sealing a floor and more particularly to a device for sealing a floor having an applicator for applying the sealant and a pad for smoothing the sealant across the floor.

In the past, applying a protective layer of sealant to a large concrete floor has been a tedious and labor intensive process. Essentially, after cleaning debris and removing stains from the floor, sealant is applied manually by mopping the sealant across the floor, waiting for the coat to dry and applying an additional coat if needed. The process is slow, labor intensive, and it is oftentimes difficult to apply the requisite number of coats in one day. This is problematic since many floors are only available for maintenance for relatively short periods of time. Not only is the process slow, but the manual techniques sometime result in an uneven application of sealant across the surface of the floor. Spilling of the sealant and storing unused sealant are other problems associated with this process.

### BRIEF SUMMARY OF THE INVENTION

It is an object of the present invention to provide a sealing device adapted to be coupled with a vehicle that significantly reduces the time and labor required to apply sealant to a floor.

It is another object of the present invention to provide a sealing device having an applicator that applies sealant to the floor and a pad that spreads the sealant evenly across the surface of the floor.

Yet another object of the present invention is to provide a method of applying a sealant to a floor by applying sealant with a sealant applicator and spreading the sealant across the floor with a pad.

In accordance with these and other objects evident from the following description of a preferred embodiment of the invention, a floor sealing device is provided that is adapted to be coupled with a vehicle for applying sealant supplied from a storage tank. The device includes a deck having at least one wheel in contact with the floor, a sealant applicator coupled with the deck and having a number of apertures along its length, and a sealant conveying line in fluid communication with the applicator and adapted to be coupled with the storage tank. The device also includes an elongated planar pad coupled with the deck and located at a distance from the applicator. The pad is adapted to be placed in contact with the floor to distribute the sealant across the floor after sealant is applied to the floor through the apertures of the applicator.

By providing a sealing device and method in accordance with the present invention, numerous advantages are realized. For example, by applying the sealant with the applicator and spreading the sealant across the surface of the floor with the pad, an evenly distributed coat of sealant is produced. Additionally, the applicator and pad allow sealant to be applied to a large strip of the floor in a single pass. Since the device is adapted to be coupled with a vehicle, each coat may be applied quickly by a single operator. The device and method save both time and money, and result in a floor that is sealed more efficiently and at greatly reduced labor costs than by traditional methods.

### BRIEF DESCRIPTION OF THE SEVERAL VIEWS OF THE DRAWING

The objects and features of the invention noted above are explained in more detail with reference to the preferred embodiment illustrated in the attached drawing figures, in which like reference numerals denote like elements, and in which:

FIG. 1 is a side perspective view, taken from above, of the sealing device of the present invention and a vehicle used in conjunction with the device.

FIG. 2 is a fragmentary top plan view of the sealing device and vehicle.

FIG. 3 is a fragmentary elevational view of the sealing device and vehicle illustrating the pad in contact with the floor.

FIG. 4 is a rear elevational view of the sealing device of FIG. 3.

FIG. 5 is a fragmentary elevational view of the sealing device and vehicle illustrating the pad at a distance from the floor.

FIG. 6 is an enlarged, fragmentary plan view of the spreading pad secured to the beam.

FIG. 7 is an enlarged, fragmentary perspective view illustrating the connection between the sealant applicator and the deck of the sealing device.

### DETAILED DESCRIPTION OF THE INVENTION

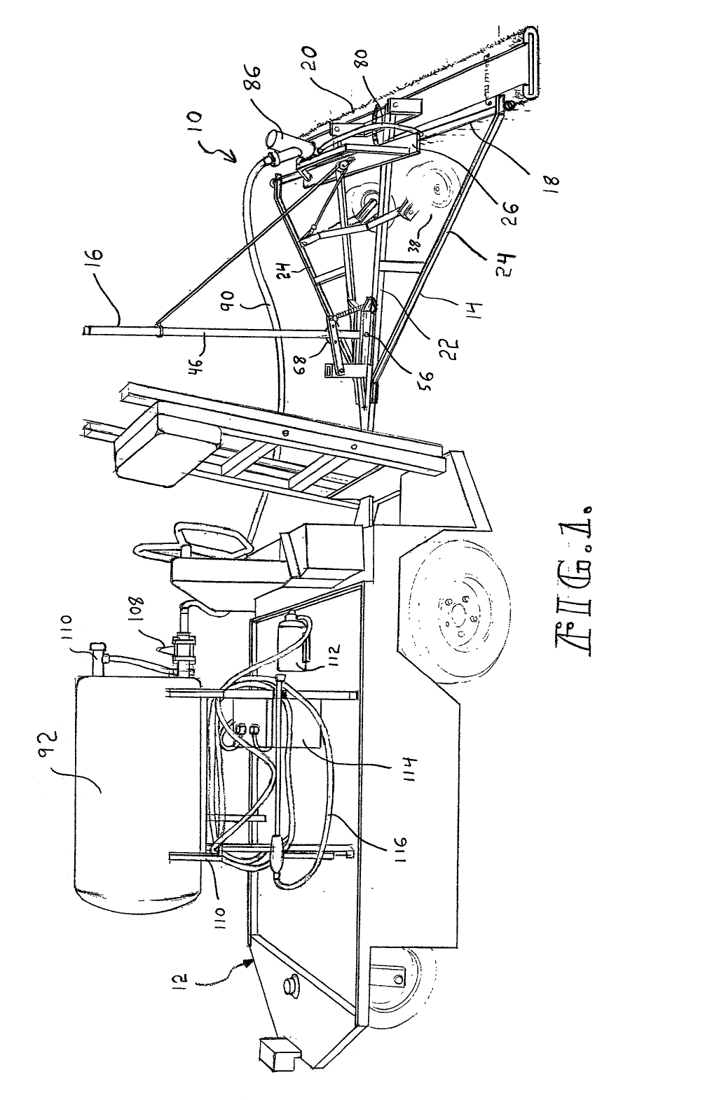

As shown in FIG. 1, a floor sealing device constructed in accordance with a preferred embodiment of the present invention is designated generally by reference numeral 10, and is adapted to be coupled with a vehicle 12. The sealing device includes a support deck 14, a height adjustment assembly 16, a sealant applicator 18 and a spreading pad 20.

With reference to FIG. 2, the support deck 14 of the sealing device includes a pair of primary supports 22, a pair of secondary supports 24 and a rear platform 26. The primary supports 22 are hollow steel tubes that are integral with one another at one end of each support, and diverge from one another as they extend in the direction of the rear platform 26. A loop 28 is welded to the integral ends of the primary supports, and is adapted for coupling the deck of the sealing device to the vehicle. The primary supports 22 are welded to the rear platform 26, and extend beyond the rear support 26. A pair of apertures (not shown) are located at the end of either support for pivotally mounting the pad 20 to the deck as described below.

The secondary supports 24 are steel bars located about either side of the primary supports 22. Each secondary support 24 is secured to a corresponding primary support 22 at one end, and are secured to one of the ends of the applicator 18 at the other end. A pair of braces 30 provide lateral support to the deck. Each brace 30 is secured between a midpoint along the length of a primary support 22 and a midpoint of a corresponding secondary support.

With reference to FIG. 2, a pair of bearings 32 extend downwardly from either of the primary supports 22. An axle 34 is supported between the bearings 32. At either end of axle 34, a wheel support 36 is secured to the axle. A wheel 38 is pivotally secured to the end of each wheel support by a pin 40. Each wheel support is a relatively short rectangular member.

The height adjustment assembly includes a bracket 42, a tensioning line 44 and a lever 46. The bracket 42 is welded to each of the wheel supports 36 at either end of the forked bracket. Each side of bracket extends from a wheel support 36 and terminates at an arm 48 disposed at a small distance from the arm of the other side of the bracket. A bolt 50 is placed through a pair of matching apertures (not shown) in the opposing arms 48 of the bracket, and a nut 52 is placed on the end of the bolt.

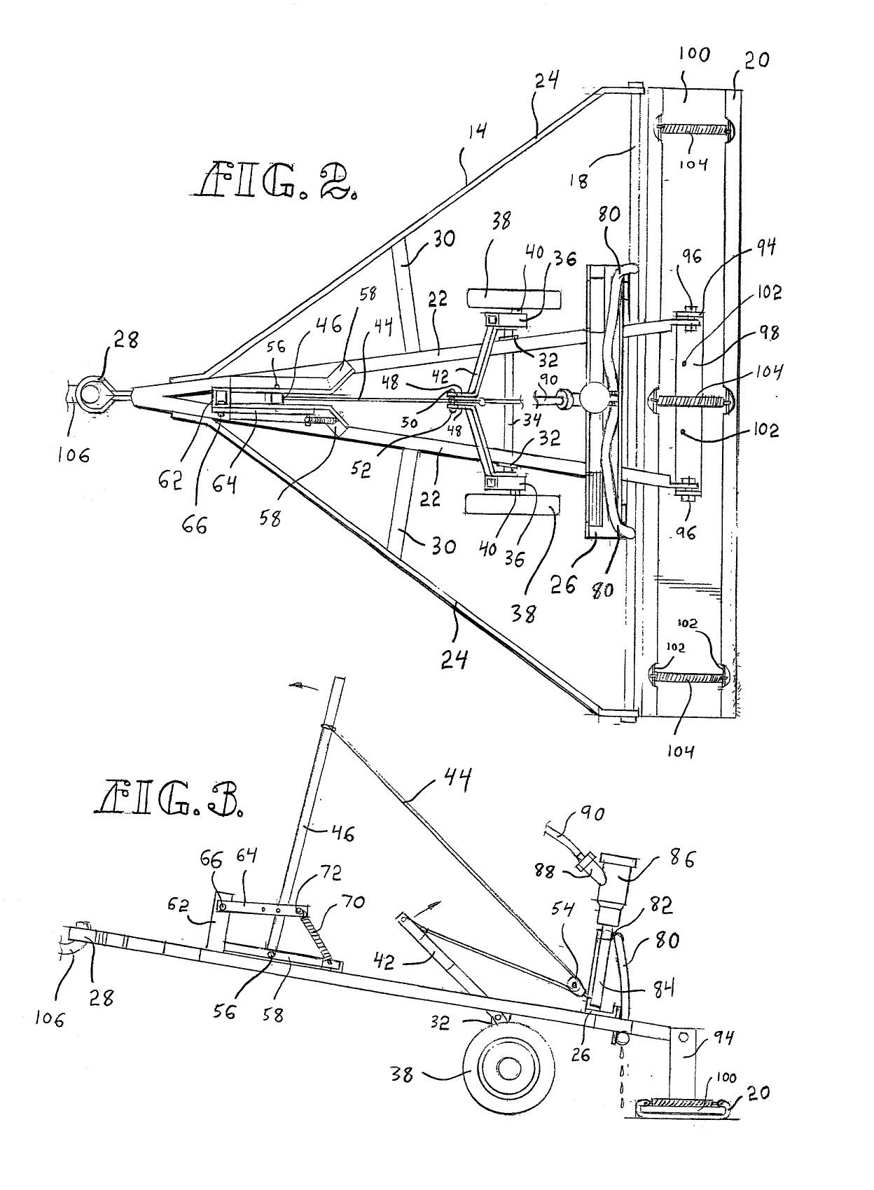

The tensioning line 44 is tied to the bolt between the arms 48 of the bracket 42. With reference to FIG. 3, the line 44 extends around a pulley 54 secured to the deck at the rear platform 26, and in the direction of the lever 46. The line 44 is tied around the upper end of the lever 46. With reference to FIGS. 2 and 3, the lever 46 is pivotable about a pin 56 disposed between a pair of mounts 58. A flared end of each mount 58 is welded to the one of the primary supports 22 of the deck 14. The opposite end of each mount 58 is welded to a post 62 upstanding from the primary supports 22. At the upper end of the post 62, a biasing lever 64 is pivotally secured to the post at a pin 66. As shown in FIG. 1, a sleeve 68 extends from the biasing lever 64 and about the lever 46 at a distance from the pin 56. With reference back to FIG. 3, at the end of the biasing lever 64 opposite the post 62, a spring 70 is attached to the lever 46 at an aperture 72. The opposite end of the spring 70 is secured to the flared end of one of the mounts 58 so that the spring 72 biases the lever 64 downwardly in the direction of the flared end of the mount. Since the biasing lever 64 is coupled with the lever 46, the lever 46 is biased in the direction of the pulley 54.

With reference to FIG. 1, the sealant applicator 18 is secured to the underside of rear platform 26 and extends laterally in either direction from the platform. As mentioned above, each end of the applicator 18 is secured to the ends of the secondary supports 24. Additionally, as shown in FIG. 7 on either side of rear platform 26, a tab 76 extends downwardly is welded to the applicator 18. With reference to FIG. 4, the sealant applicator 18 includes an elongated tubular manifold having a plurality of downwardly directed apertures 74 located along its length. Either end of the manifold is capped, and sealant is supplied to the manifold by a pair of tubular connectors 78 on either side of the center of the manifold.

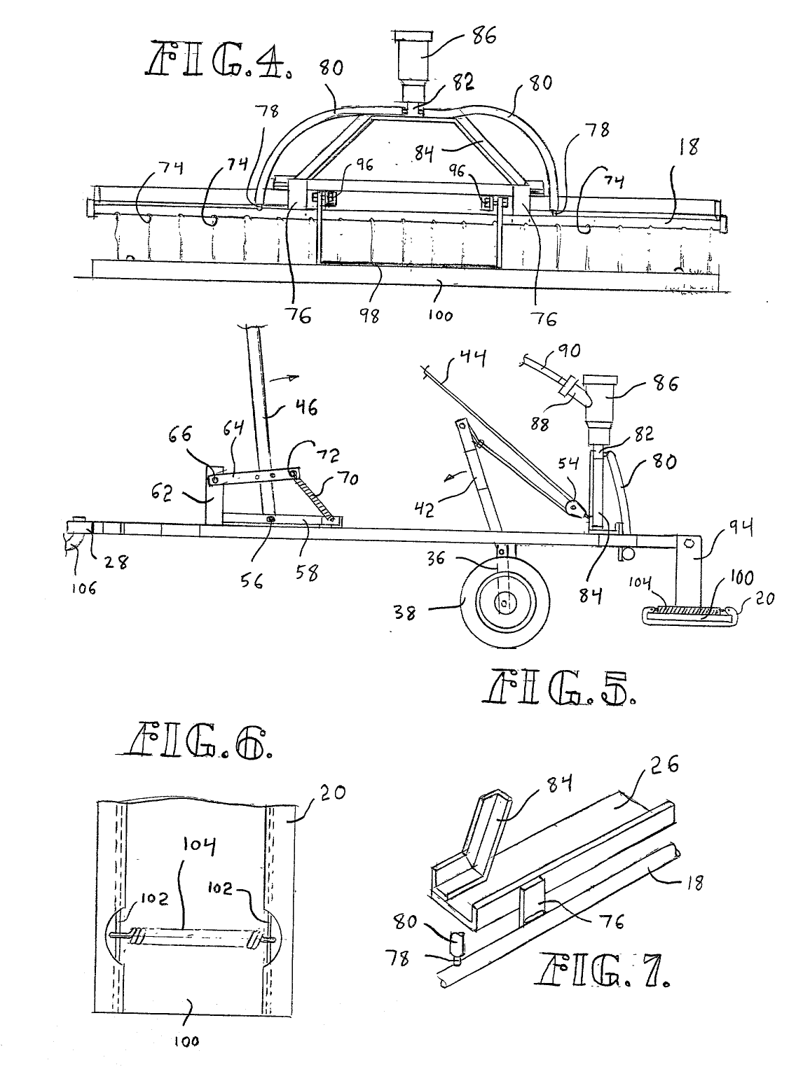

A pair of hoses 80 are coupled with the connectors 78. The opposite end of each hose is connected to a T-valve 82 supported by a bracket 84 secured to either end of the rear platform 26 of the deck. As shown in FIG. 5, a filter housing 86 is secured to the T-valve 82, and includes an inlet 88 and an interior cavity (not shown) for removably housing a sealant filter (not shown). A sealant conveying line 90 is secured to the inlet and is in fluid communication with a supply tank 92 (FIG. 1) located on the vehicle as described below.

With reference to FIGS. 2 and 3, the pad 20 is pivotally secured to the ends of the primary supports 22 by a bracket 94. Specifically, as shown in FIGS. 2 and 4, each end of the bracket 94 has an aperture that is placed in alignment with an aperture located at the end of each support 22. A pair of nut and bolt fasteners 96 are employed at the apertures to secure the bracket to the supports.

As shown in FIG. 2, the bracket includes a base 98 that is secured to an elongated beam 100 extending laterally in a direction parallel to the sealant applicator 18 to a length slightly greater than that of the applicator. The beam is made of wood with a rectangular cross section of one inches by six inches, and has a length of about four feet. A pair of screws 102 are placed through apertures within the base 98 of the bracket and into the beam 100. The spreading pad 20 is wrapped about the beam 100. The pad is made of a synthetic lambswool material. Alternatively, the pad may be made of any of a number of soft, absorbent materials such as cotton, natural lambswool and fabric having similar properties.

With reference to FIG. 6, at either edge of pad 20, a thin rod 102 is sewn within a fold of the pad. With reference to FIG. 2 the rods 102 are exposed at a number of location along the length of the pad. Three springs 104 are secured to the rods 102 to hold the pad 20 tightly about the beam 100.

As shown in FIGS. 2 and 3, the floor sealing device of the present invention is secured to the vehicle 12 by placing the loop 28 over a hook 106 extending from the rear of the vehicle.

With reference to FIG. 1, the sealant conveying line 90 is adapted to be placed in fluid communication with the sealant supply tank 92 through a check valve 108 disposed near the bottom of the tank. The check valve 108 is in communication with a tank outlet 110. The tank 92 is supported on the vehicle 12 by a frame 110. A pump 112 powered by a battery 114 are also supported by the vehicle. The pump 112 is in communication with the tank 92 by way of a line 116 and applies pressure to the sealant within the tank.

In operation, the sealant in the supply tank 92 is pressurized by pump 112. Prior to application, the valve 108 is placed in the closed position. When the lever 46 is in the position illustrated in FIG. 3, the wheels 38 are located a small distance from the deck 14 so that the deck is angled downwardly from the hook 106 of the vehicle. In this position, the pad 20 is in contact with the floor. Next, the check valve 108 is opened so that sealant begins to flow through the sealant conveying line 90 and into the inlet 88 on the filter housing 86. The sealant passes through the filter disposed within the filter housing and the filtered sealant is directed through the T-valve 82. Next, the sealant passes through the hoses 82 and into the sealant manifold 18. As shown in FIG. 4, sealant drips evenly through the apertures 74 along the length of the applicator. At this point, the vehicle is put in forward motion. With reference back to FIG. 3, as the applicator applies the sealant, the pad 20 spreads the sealant across the surface of the floor. The smooth, soft surface of the pad spreads the sealant evenly across the length of the pad and assures a uniform coating of sealant is applied to the floor.

It is necessary to make multiple passes with device 10 to cover a large concrete floor. This requires frequent turning of the vehicle towing the device 10. With reference to FIG. 1, when the operator is ready to turn the vehicle, the operator may stop the flow of sealant from the supply tank 92 to the applicator 18 by moving check valve 108 to the closed position. With reference to FIG. 3, to raise the pad from contact with the floor, the operator pulls the lever 46 in the direction of the arrow. When the lever 46 is pulled in this direction, the tensioning line 44 pulls the bracket 42 of the height adjustment assembly 16 in the direction of the arrow. Turning to FIG. 5, as the lever 46 is pivoted to a generally vertical orientation with respect to the deck 14, the bracket 42 is pivoted so that the wheel supports 36 are generally vertical with respect to the floor. In this position, the deck 14 is generally parallel with the floor, and the pad 20 is disposed at a distance from the floor.

Since the lever 46 is biased in the direction of the pulley 54, the operator is required to hold the lever in the generally vertical position to maintain the pad at a distance from the surface of the floor. Alternatively, a locking mechanism may be employed to hold the lever in this position.

For instance, the operator may desire to maintain the deck in the position illustrated in FIG. 5 when traveling from one location to another, or when storing the sealing device.

Once the vehicle is in the proper position to apply the next row of sealant, the operator allows the lever to move in the direction of the arrow in FIG. 5. As the lever 46 pivots toward the pulley, the bracket 42 of the height adjustment assembly moves in the direction of the arrow in FIG. 5. As the wheel supports 36 pivot, the deck moves to the position illustrated in FIG. 3, and the pad is again placed in contact with the surface of the floor. Once the operator moves the valve 108 to the open position, sealant is provided to the applicator 18, and a subsequent row of sealant is provided to the floor by moving the vehicle in the forward direction. The process is repeated until the entire surface of the floor is sealed.

While the invention is shown with respect to a preferred embodiment. For example, in one alternative, multiple sealing devices may be coupled with a single vehicle to apply sealant to a wide row. Also, a wide range of vehicles including tractors, all terrain vehicles ATVs, forklifts and other vehicles may be utilized in accordance with the present invention. Additionally, a vehicle for pulling the sealing device may be used that the user walks behind instead of operating while riding the vehicle. In another alternative, the storage tank may be supported by the deck or at another location apart from the vehicle. In yet another alternative, a hand powered pump may be substituted for the battery driven pump of the preferred embodiment. Also, various structures for supporting the components of the present invention and controlling the height of the pad may be employed without departing from the scope of the invention.

From the foregoing it will be seen that this invention is one well adapted to attain all ends and objects hereinabove set forth together with the other advantages which are obvious and which are inherent to the structure. It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A device adapted to be coupled with a vehicle for applying sealant supplied from a storage tank to a floor, the device comprising:
a deck having at least one wheel in contact with the floor;
a sealant applicator coupled with said deck and having a plurality of apertures along its length;
a sealant conveying line in fluid communication with said applicator and adapted to be coupled with the storage tank, and
an elongated planar pad coupled with said deck and located at a distance from said applicator, said pad adapted to be placed in contact with the floor to distribute the sealant across the floor after the sealant is applied to the floor through said apertures of said applicator.

2. A device as recited in claim 1, wherein said pad extends to a length greater than said applicator.

3. A device as recited in claim 1, wherein said pad is wrapped about the exterior of an elongated beam, said beam rotatably coupled with said deck.

4. A device as recited in claim 3, wherein said pad is made of synthetic lambs wool.

5. A device as recited in claim 1, wherein said wheel is pivotally coupled with said deck.

6. The device as recited in claim 5, wherein said wheel is pivotable between a first position and a second position, wherein said pad is placed in contact with the floor when said wheel is in said first position and said pad is placed at a distance from the floor when said wheel is in said second position.

7. The device as recited in claim 6, further comprising a lever rotatably coupled with said deck and coupled with said wheel, wherein said wheel is moveable between said first and second positions by pivoting said lever.

8. The device as recited in claim 7, wherein said lever is coupled with said wheel by a tensioning line, and wherein said device further comprises a pulley coupled with said deck about which the tensioning line is held between said lever and said wheel.

9. The device as recited in claim 8, wherein said lever is biased in the direction of said pulley, and wherein said wheel is moved from said first position to said second position when said lever is pulled in the direction opposite the pulley.

10. The device as recited in claim 9, wherein two wheels are coupled with said deck.

11. A method for applying a sealant to a floor, the method comprising the steps of:
providing a storage tank containing sealant;
providing a sealant applicator having a plurality of apertures along its length;
supplying sealant from said storage tank to said sealant applicator through a sealant conveying line;
applying sealant to the floor through said apertures in said sealant applicator, and
spreading the sealant across the floor with an elongated pad disposed at a distance from with said sealant applicator.

12. The method as recited in claim 11, further comprising the step of lowering said paid into contact with the floor before applying the sealant.

13. The method as recited in claim 12, further comprising the step of raising said pad to a distance from the floor after applying sealant to the floor.

14. The method as recited in claim 11, wherein said storage tank is located on a vehicle, and wherein said sealant applicator and said pad are adapted to be coupled with said vehicle.

15. A device adapted to be coupled with a vehicle for applying sealant supplied from a storage tank to a floor, the device comprising:
means for supporting a wheel in contact with the floor, said supporting means adapted to be coupled with the vehicle;
means for applying the sealant to the floor, said applying means coupled with said supporting means;
means for conveying the sealant from the tank to said applying means, said conveying means adapted to be coupled with the storage tank, and
means for spreading the sealant across the floor, said spreading means coupled with said supporting means at a distance from said applying means and adapted to be placed in contact with the floor.

16. The device of claim 15, further comprising means for adjusting the height of said spreading means between a first position in contact with the floor and a second position at a distance from the floor.
